(19) United States
(12) Patent Application Publication
(10) Pub. No.: US 2019/0351475 A1
(43) Pub. Date: Nov. 21, 2019

(54) NEAR-NET FORGING OF CAST METAL PART

(71) Applicant: Microsoft Technology Licensing, LLC, Redmond, WA (US)

(72) Inventors: Zhicong YAO, Seattle, WA (US); Malcolm Stewart EARLY, Mercer Island, WA (US); Byungkwan MIN, Kirkland, WA (US); Luke Michael MURPHY, North Bend, WA (US)

(73) Assignee: Microsoft Technology Licensing, LLC, Redmond, WA (US)

(21) Appl. No.: 15/983,031

(22) Filed: May 17, 2018

(51) Int. Cl. B21J 5/00; B21J 1/04; B21J 9/08; B21C 25/02

(52) U.S. Cl. CPC B21J 5/002; B21J 1/04; B23P 23/02; B21C 25/02; B21J 9/08

(57) ABSTRACT

A method for use in manufacturing a metal part is provided. The method may include casting liquid metal in a ceramic mold. The ceramic mold may be formed via an investment casting process in which a wax mold is used to as a form for the ceramic mold, and the wax is melted away from the ceramic mold prior to its use. The method may further include cooling the liquid metal in the ceramic mold to form a solid metal part, and then divesting the ceramic mold to release the metal part. The metal part may include an imperfection in a shape of the metal part. To correct the imperfection, the method may include shaping the metal part by near-net shape forging.

### BACKGROUND

Metal parts formed in complicated shapes may be created by a variety of methods, including die casting and metal injection molding. However, these processes are limited to use with certain types of metals. Die casting is conventionally performed with metals characterized by low melting temperatures, such as zinc, aluminum, and magnesium. Such limitations in material may result in metal parts with compromised strength. The cast metal parts may also include imperfections in shape, such as bowing or twisting. Metal injection molding can be performed with a wide range of metal and metal alloys, but the metal is powdered and mixed with a binder before shaping and solidification. This technique can result in cosmetic surface defects such as inclusions and porosities, even after the metal part is polished or plated. Additionally, plating the metal parts with elements such as chromium may result in corrosion issues. Further, the designs used for creating the metal parts with these processes may have reduced flexibility, thereby limiting the complexity of the finished metal part.

### SUMMARY

To address the above issues, a method for use in manufacturing a metal part is provided. The method may include casting liquid metal in a ceramic mold that is formed by an investment casting process. The method may further include cooling the liquid metal in the ceramic mold to form a solid metal part. The method may further include divesting the ceramic mold to release the metal part. The metal part may have an imperfection in a shape of the metal part. The method may further include shaping the metal part by near-net shape forging to correct the imperfection in the shape of the metal part.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a top perspective view of an example metal part according to one implementation of the present disclosure.

FIG. 2 shows a bottom perspective view of the metal part of FIG. 1.

FIG. 3 shows a flowchart of a method for use in manufacturing a metal part according to one implementation of the present disclosure.

FIG. 4. shows a photographic top view of a cast metal part according to the metal part of FIG. 1.

FIG. 5 shows a flowchart of a method for forming a ceramic mold for use in casting a metal part, according to one implementation of the present disclosure.

FIG. 6 shows a photographic top view of a wax mold for use in manufacturing the metal part of FIG. 1.

FIG. 7 shows a flowchart of a method for forging a cast metal part, according to one implementation of the present disclosure.

FIG. 8 shows a schematic side view of a die set for use in forging the metal part of FIG. 1.

FIG. 9 shows a schematic side view of the metal part of FIG. 1.

FIG. 10 shows a schematic side view of a forging mold to correct an imperfection in a torsion of the metal part of FIG. 1.

FIG. 11 shows a schematic side view of a forging mold to correct an imperfection in a length of the metal part of FIG. 1.

FIG. 12 shows a schematic top view of the metal part of FIG. 1.

FIG. 13 shows a partial schematic top view of a forging mold to correct an imperfection in a width of the metal part of FIG. 1.

FIG. 14 shows a partial schematic top view of a forging mold to correct an imperfection in a perforation of the metal part of FIG. 1.

FIG. 15 shows a partial schematic side view of a forging mold to correct an imperfection in a perforation of the metal part of FIG. 1.

FIG. 16 shows a flowchart of a method for finishing a cast and forged metal part, according to one implementation of the present disclosure.

FIG. 17 shows a photographic top view of a forged and polished metal part according to the metal part of FIG. 1.

FIG. 18 shows a photographic perspective view of a metal part before forming according to another implementation of the present disclosure.

FIG. 19 shows a photographic perspective view of the metal part of FIG. 18 after forming according to another implementation of the present disclosure.

FIG. 20 shows a schematic diagram of a cold drawing process according to another implementation of the present disclosure.

FIGS. 21A-21C show schematic views of cross-sections of rollers used in the cold drawing process of FIG. 20.

FIG. 22 shows a flowchart of a method for shaping a metal part according to another implementation of the present disclosure.

FIG. 23 shows an example computing system according to one implementation of the present disclosure.

### DETAILED DESCRIPTION

The inventors of the subject application have discovered that creating a metal part having a complex shape using conventional methods may result in a metal part with decreased strength, imperfections in the shape of the metal part, and cosmetic defects in the finish of the metal part. Typically, complex metal parts, such exterior parts for computing devices, are made by die casting or metal injection molding processes. However, these methods are limited in the type of material that can be used for the metal parts. For example, a compacted metal powder is used in metal injection molding, which has a decreased density, and thus strength, compared to pure metals. Additionally, imperfections in the shape of the metal part, such as bowing or inaccurate dimensions may result in limited functionality and/or a poor fit with adjacent components when the metal part is mounted on the computing device. Further, cosmetic defects such as inclusions, porosities, and sink marks are often found in metal parts created by these processes. Finally, the designs available for use with the above processes may have limited flexibility, thereby hindering the complexity of the finished metal part.

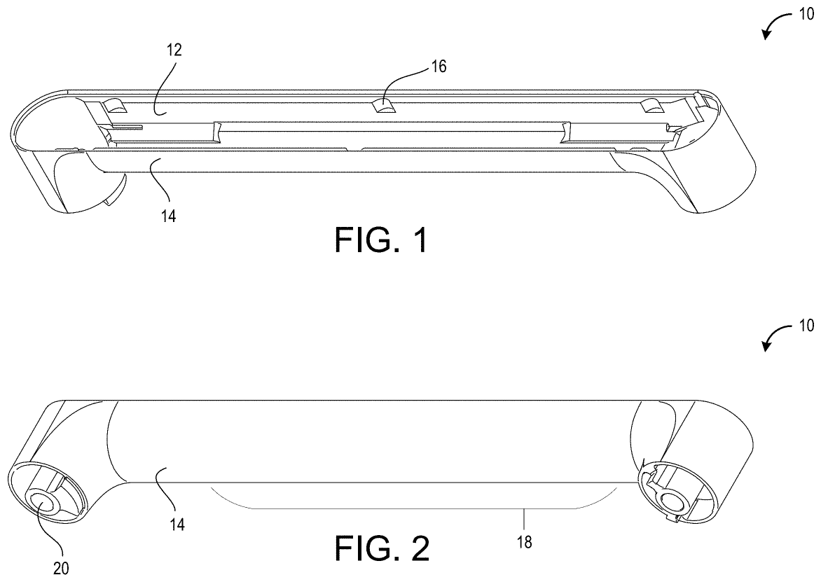

To address the above issues, methods for manufacturing a complex metal part are provided. Looking first at FIGS. 1 and 2, top and bottom perspective views, respectively, are shown for an exemplary metal part 10 that made be created using the methods described herein. The dimensions and shape of the metal part 10 may be based on a model created with a computer-aided design (CAD) program. Each of the steps in the methods may refer to the CAD model to ensure that the dimensions and shape of the metal part 10 are accurate. The metal part 10 described herein is configured as a hinge arm for a computing device. However, it will be appreciated that the metal part 10 may be another complex metal part. For example, the methods described herein for manufacturing a complex metal part are particularly suited to metal parts of computing devices that have an exposed metal cosmetic surface, including hinges, spines, and earphones.

As shown in FIG. 1, the metal part 10 may have an internal surface 12 and an external surface 14. The internal surface 12 may include at least one contoured feature 16. In contrast, as shown in FIG. 2, the external surface 14 may exhibit a straight, smooth expanse 18. The metal part 10 may further include one or more perforations 20.

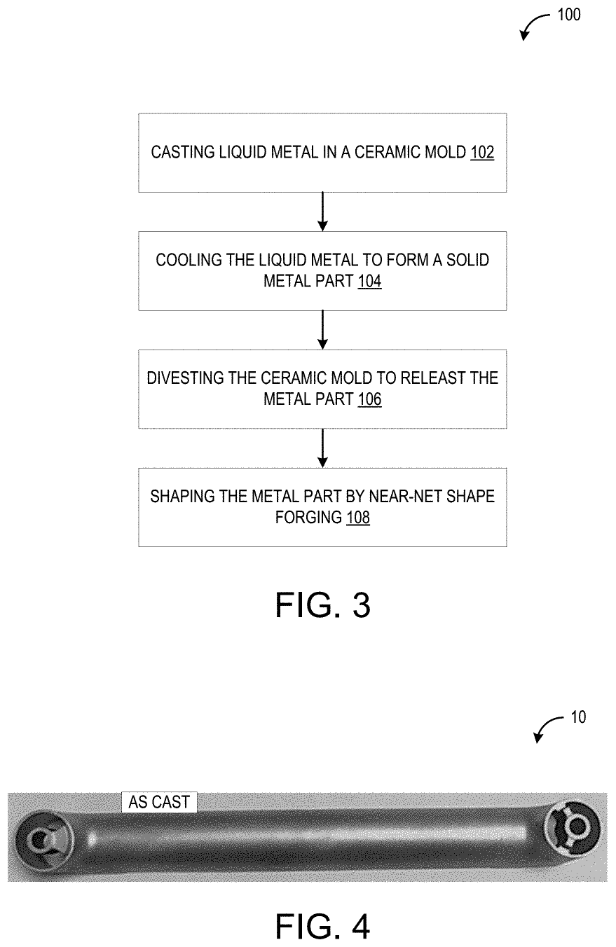

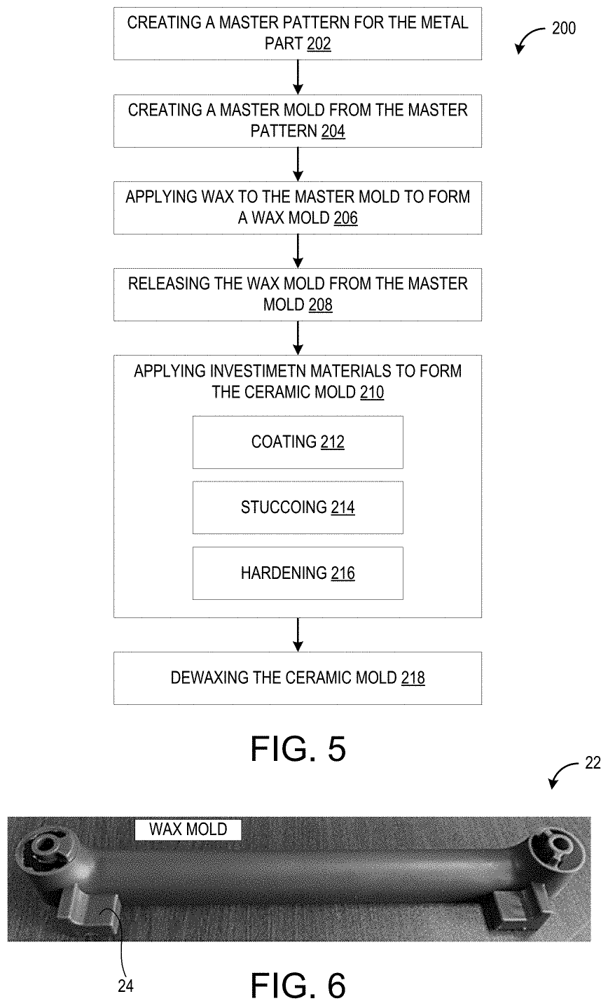

FIG. 3 shows method 100 for use in manufacturing a metal part, such as the metal part 10 shown in FIGS. 1 and 2. At step 102, the method 100 may include casting liquid metal in a ceramic mold. The ceramic mold may be formed via an investment casting process, as described in detail below with reference to FIG. 5. The ceramic mold may be pre-heated and is configured to include a hollow cavity of a desired shape into which liquid metal is poured. In the methods described herein, the liquid metal is preferably stainless steel, but it will be appreciated that the metal may be another suitable material, such as aluminum alloys, bronze alloys, and cast iron, for example.

Continuing to step 104, the method 100 further may include cooling the liquid metal in the ceramic mold to form a solid metal part. Typically, the liquid metal is allowed to reach ambient environmental temperature through transient heat transfer. Actively cooling the liquid metal may damage the ceramic mold, as well as lead to increased shrinkage and molecular stress of the metal part 10, as the cooling process is not likely to be uniform.

At step 106, the method 100 may include divesting the ceramic mold to thereby release the metal part 10. A photographic example of the metal part 10 after casting is shown in FIG. 4. While the investment casting process preserves a complexity of the metal part 10, the metal part 10 may include an imperfection in a shape of the metal part 10. Such imperfections are often due to shrinkage of the metal part 10 as the liquid metal solidifies and may include imperfections in the torsion, length, and width of the metal part 10, as discussed in detail below.

To correct the imperfection, step 108 of the method 100 may include shaping the metal part 10 by near-net shape forging. Near-net shape forging is a process that results in a product that requires little or no machining, with dimensional tolerances that are very close to that of a finished shape. It may be desirable to use near-net shape forging for metal parts with complex shapes, as this process allows for detailed geometric features. Additionally, forging a cast metal part with near-net shape forging eliminates waste material, or flash, which reduces the amount of starting material and generates an economic benefit. As discussed above, the finished shape and dimensions may be based on a CAD model.

In some cases, it may be desirable to include applying a flat press to the metal part 10 to straighten the metal part 10 after casting and before shaping with near-net shape forging. This process may be performed when it is critical for the metal part 10 to be precisely straight, such as a metal part 10 that is configured to attach to another component to form an outer element of a computing device.

FIG. 5 shows a method 200 for forming a ceramic mold for use in casting the metal part 10, according to the method of FIG. 3. As discussed above, the ceramic mold is formed via an investment casting process. Investment casting is a modern industrial practice based on the process of lost-wax casting, in which a wax mold serves as the form for a desired metal part. The wax is melted, or “lost,” during the process. Investment casting can be applied to create metal parts ranging from a few ounces, such as jewelry, to several hundreds of pounds, such as machine parts. Notably, investment casting produces metal parts with complicated shapes that would be challenging to achieve with other casting methods. Metal parts formed by investment casting typically exhibit smooth exterior surfaces and low tolerances that reduce the need for tedious and expensive finishing and/or machining processes.

As shown in FIG. 5, the method 200 for forming a ceramic mold via investment casting may include a first step 202 of creating a master pattern for the metal part 10. The master pattern may be formed of a wide variety of materials, including metal, wood, clay, plastic, or wax. The master pattern may also be printed in polylactic acid (PLA) filaments using 3D printing technology. At step 204, the method 200 may include creating a master mold from the master pattern. The master mold is cast directly from the master pattern using a material such as rubber or metal. Advancing from step 204 to step 206, the method 200 may include applying melted wax to the master mold to form a wax mold. Wax expands when heated, and will thus shrink away from the inner surface of the master mold as it solidifies. Accordingly, creating the master mold includes a shrinkage calculation to accommodate shrinkage of the wax as it solidifies. This calculation ensures that the metal part 10 will be formed with desired dimensions.

At step 208, the method 200 may include releasing the wax mold from the master mold. FIG. 6 shows a wax mold 22 formed in the shape of the metal part 10. The investment casting process may include a forming gating system 24, as seen on the wax mold 22 in FIG. 6. The gating system 24 provides a channel or channels for the liquid metal to enter the ceramic mold cavity and may be removed prior to forging the metal part 10.

Advancing to step 210, the method 200 may include applying investment materials to the wax mold 22 to form the ceramic mold. The application of investment materials may comprise at least one cycle of the steps of coating, stuccoing, and hardening. Accordingly, at step 212, the method 200 may include coating the wax mold 22 by dipping the wax mold 22 into a slurry of fine refractory material. The coating step 212 preserves the fine detail of the wax mold 22. Following the coating at step 212, the method 200 may include stuccoing at step 214. Stuccoing includes applying coarse ceramic particles to the coated wax mold 22. The stuccoing step 214 provides strength and integrity to the ceramic mold. At step 216 of the method 200 may include hardening, wherein hardening comprises allowing the coating and stuccoing to cure. When the ceramic mold has reached a desired thickness after one or more cycles of coating, stuccoing, and hardening, at step 218 the method 200 may include dewaxing the ceramic mold by heating the ceramic mold to melt the wax. After dewaxing, the ceramic mold may undergo a burnout process in which the ceramic mold is heated at high temperatures to remove any residual wax and/or moisture. The ceramic mold is then ready to be used for casting the metal part 10, as described above in method 100, with reference to FIG. 3.

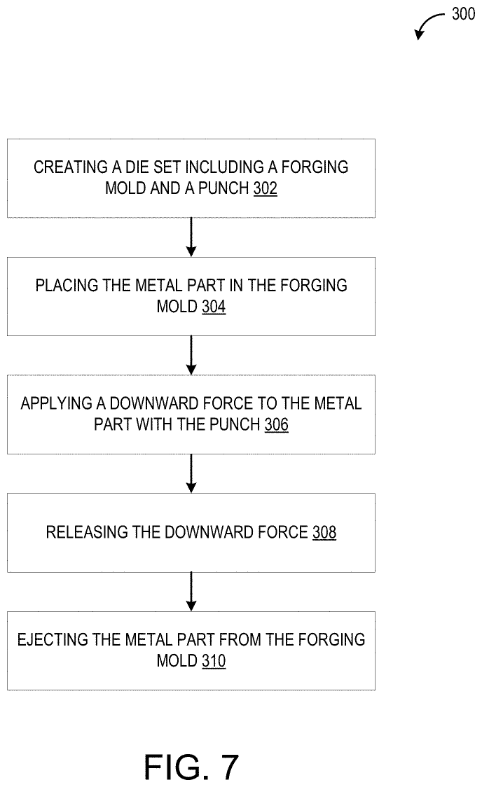

FIG. 7 shows a flowchart for a method 300 for near-net shape forging. At step 302, the method 300 may include creating a die set 26 for shaping the metal piece 10. Turning briefly to FIG. 8, a schematic side view of the die set 26 for use in shaping the metal piece 10 is shown. The die set 26 may include a forging mold 28 and a punch 30. The forging mold 28 may have a void 32 in a shape compatible with the external surface 14 of the metal part 10. Accordingly, the punch 30 may have a face 34 formed in a shape compatible with the interior surface 12 of the metal part 10. The profile of the metal part 10 is indicated by the dashed line in FIG. 8.

Continuing with FIG. 7, at step 304 the method 300 may include placing the metal part 10 in the forging mold 28. Advancing to step 306, the method 300 may include applying a downward compressive force to the metal part 10 with the punch 30 to plastically deform the metal part 10 to adapt to the shapes of the forging mold 28 and the punch face 34. The duration of the compressive force may range from a brief impact that lasts a few milliseconds to a sustained application of continuous pressure that can be measured in seconds. In the methods described herein, the near-net shape forging is preferentially performed as a cold forging process, in which the metal part 10 is typically in a sustained contact with the die set 26. However, it will be appreciated that the methods and die set 26 described herein may be used in a warm forging process and/or a hot forging process.

When a desired duration of applying the downward compressive force has been achieved, at step 308 the method 300 may further include releasing the downward compressive force by lifting the punch. In the methods described herein, shaping the metal piece is achieved by a single application of the punch 30 to the metal part 10 in the forging mold 28. However, it will be appreciated that steps 306 and 308 may be repeated to provide multiple applications of the downward compressive force to shape the metal part 10. To complete the forging process, at step 310 the method may include ejecting the forged metal part 10 from the forging mold 28.

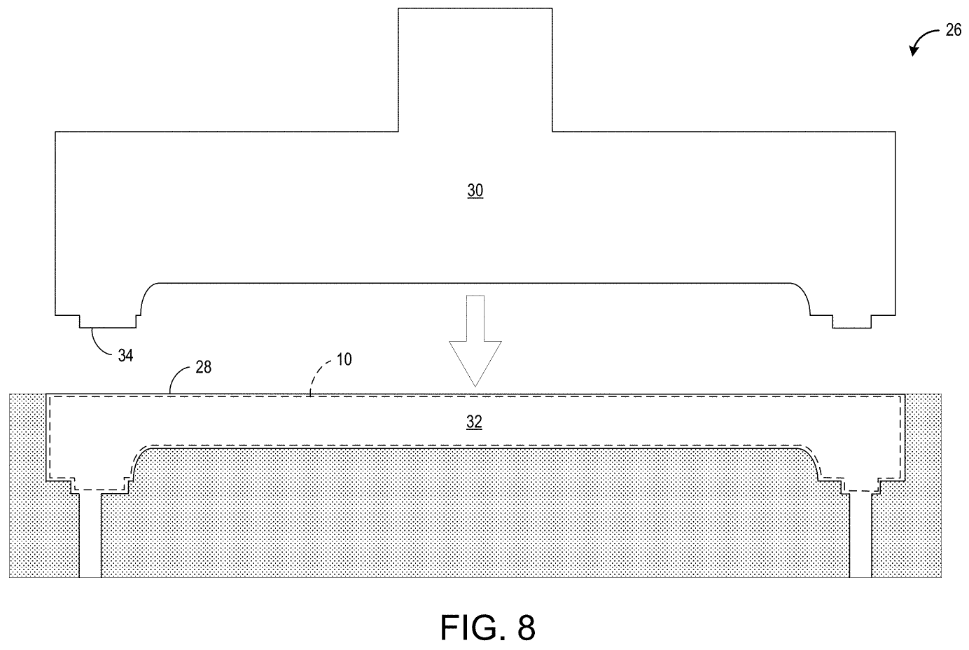

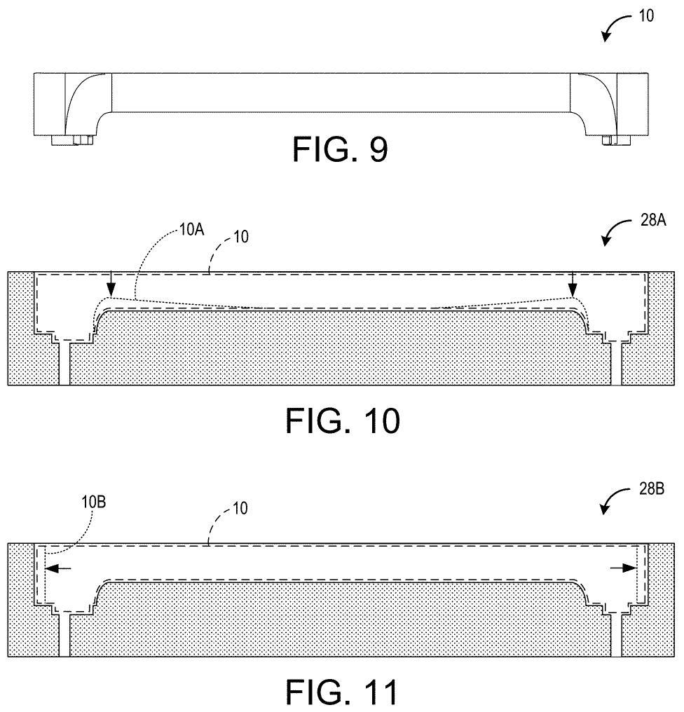

After casting, the metal part 10 may have more than one imperfection in a shape of the metal part 10. For example, the metal part 10 may have three imperfections, and the first imperfection, the second imperfection, and the third imperfection may be so unrelated to one another as to require a different die set 26 for correction of each imperfection. Accordingly, the die set 26 may be a first die set 26A, and the near-net shape forging may be a multistage forging process that includes shaping the metal part 10 with the first die set 26A to correct a first imperfection, shaping the metal part 10 with a second die set 26B to correct a second imperfection, and shaping the metal part 10 with a third die 26C set to correct a third imperfection. The first die set 26A may include a first forging mold 28A and a first punch 30A, the second die set 26B may include a second forging mold 28B and a second punch 30B, and the third die set 26C may include a third forging mold 28C and a third punch 30C. The imperfections may be, for example, a defect in torsion, length, or width of the metal part 10, described below with reference to FIGS. 9-13.

FIG. 9 shows a schematic side view of the metal part 10 in its desired shape. However, the cast metal part 10 may have a torsional imperfection that creates a bowing effect such that the metal part 10 does not have a desired straightness. Thus, the metal part 10 may be forged to correct a torsional imperfection of the metal part 10. FIG. 10 shows a schematic side view of the first forging mold 28A. As discussed above, the profile of the metal part 10 is indicated by the dashed line. The dotted line 10A indicates a profile of the metal part 10 with a torsional imperfection. As shown in FIG. 10, applying a downward compressive force to the metal part 10 with the first punch 30A may plastically deform the metal part 10 in the direction indicated by the arrows to correct the torsional imperfection.

Additionally or alternatively to the torsional imperfection, the cast metal part 10 may have an imperfection in length such that the metal part 10 is shorter in length than a desired dimension. Thus, the metal part 10 may be forged to correct a length of the metal part 10. FIG. 11 shows a schematic side view of the second forging mold 28B. As discussed above, the profile of the metal part 10 is indicated by the dashed line. The dotted line 10B indicates a profile of the metal part 10 with an imperfection in length. As shown in FIG. 11, applying a downward compressive force to the metal part 10 with the second punch 30B may plastically deform the metal part 10 in the direction indicated by the arrows to correct the imperfection in length.

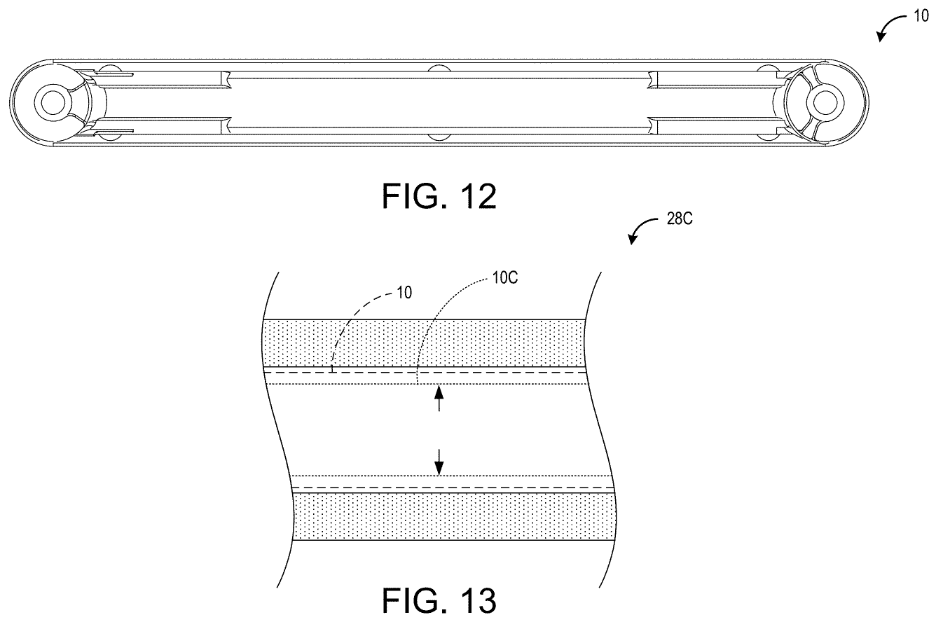

Additionally or alternatively to imperfections in torsion and/or length, the cast metal part 10 may have an imperfection in width such that the metal part 10 is narrower in width than a desired dimension. Thus, the metal part 10 may be forged to correct a width of the metal part 10. FIG. 12 shows a schematic top view of the metal part 10 in its desired shape. FIG. 13 shows a partial schematic top view of the third forging mold 28C. As discussed above, the profile of the metal part 10 is indicated by the dashed line. The dotted line 10C indicates a profile of the metal part 10 with an imperfection in width. As shown in FIG. 13, applying a downward compressive force to the metal part 10 with the second punch 30C may plastically deform the metal part 10 in the direction indicated by the arrows to correct the imperfection in width.

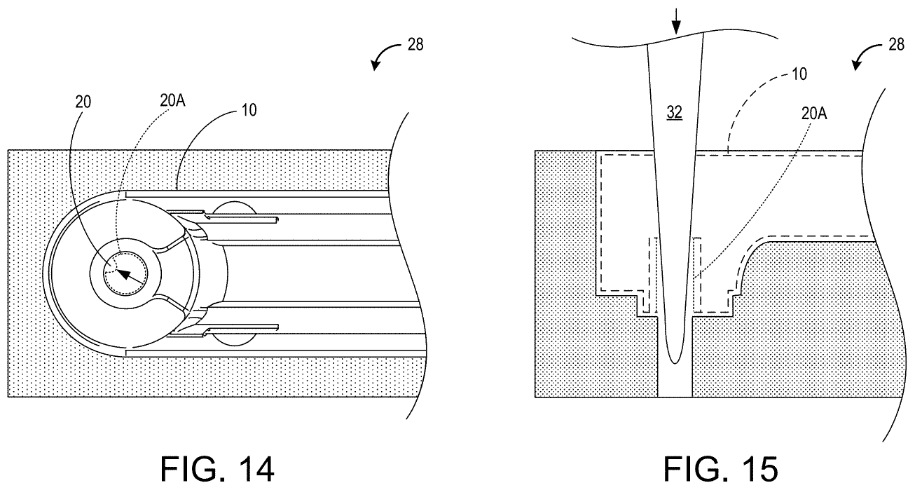

In a metal part 10 that includes one or more perforations 20, the metal part 10 may have an imperfection in the one or more perforations 20. FIG. 14 shows a partial schematic top view of the forging mold 28, with the metal part 10 placed therein. The dotted line 20A indicates an imperfection in the perforation 20. FIG. 15 shows a partial schematic side view of the forging mold 28, with the metal part 10 placed therein. To correct the imperfection in the perforation, a downward force may be applied to a piercing punch 32 inserted in the perforation 20, as indicated by the arrow in FIG. 15. In some implementations, it may be desirable to correct the perforation 20 at more than one step of the forging process. Thus, the metal part 10 may be subjected to rough piercing to correct a dimension of the perforation 20. The rough piercing may preferentially occur after the metal part 10 is shaped with the first die set 26A. However, it will be appreciated that the rough piercing may occur at any stage in the forging process. Additionally, the metal part 10 may be further subjected to fine piercing to correct the dimension of the perforation 20 to a stricter dimensional tolerance than the rough piercing. While the fine piercing may preferentially occur after the metal part 10 is shaped with the third die set 26C, it will be appreciated that the fine piercing may occur at any stage in the forging process.

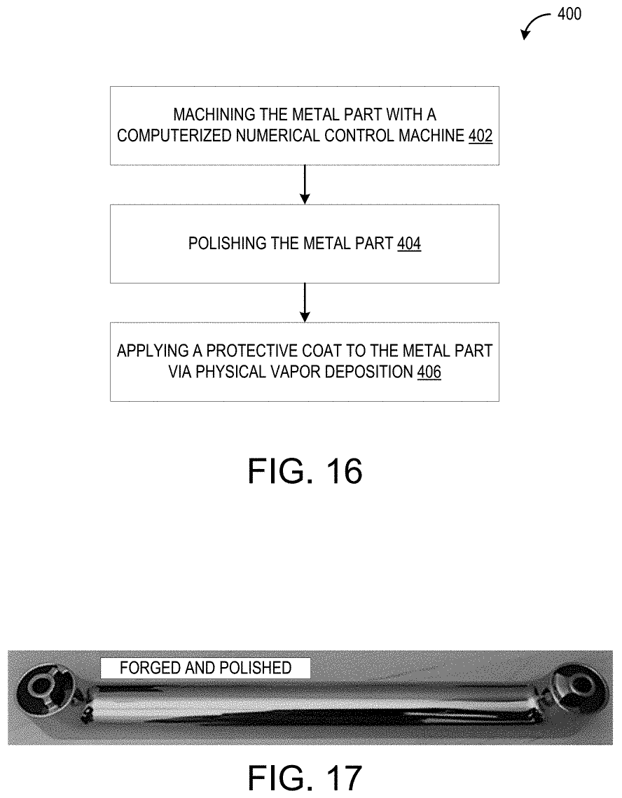

After the metal part 10 has been cast, forged, and pierced, it may be desirable to finish the metal part 10 by removing any remaining excess material, polishing the metal part 10, and applying a protective outer coat to the metal part 10. Accordingly, FIG. 16 shows a flowchart for a method 400 for finishing the cast and forged metal part 10. At step 402, the method 400 may include machining the metal part 10 after forging with a computerized numerical control (CNC) machine. CNC machines digitize metal machining processes on machine tools, such as lathes and milling machines. The movements of the CNC machine are programmed as numerical control commands that coordinate to computer-aided design (CAD) programs. As such, a user may easily update a program or change a tool parameter of the CNC machine to efficiently achieve the desired design. The CNC machine allows for precise machining operations, which is beneficial when finishing a workpiece that is near net shape, such as the metal part 10 described herein, that requires very little machining to achieve a desired shape and surface finish.

As discussed above, the metal part 10 may be used as a cosmetic surface component of a computing device. As such, it may be desirable to polish the metal part 10 after it is forged and cast. Accordingly, at step 404 the method 400 may include polishing the metal part 10 after forging. The polishing may be performed, for example, with a series of polishing compounds, materials, and wheels. Working from a rough grit, to a fine grit, and then polishing with diamond paste may achieve a mirror finish on the metal part 10, such as the photographic example of the metal part 10 shown in FIG. 17.

To protect the metal part 10 from environmental impacts that may lead to aesthetic defects such as corrosion, it may be desirable to coat the metal part 10 with a thin film. As such, at step 406 the method 400 may include applying a protective coating to the metal part 10 after forging via physical vapor deposition (PVD). PVD is a vacuum deposition process in which a coating material advances from a condensed solid or liquid phase, to a vapor phase, and then back to a condensed solid phase. The coating material can be applied to the metal part 10 using sputtering or evaporation, for example.

In some scenarios, it may be desirable to shape a complex metal part in a manner such that delicate features do not deform or break off during the process of forming the metal part. For example, the metal part may include a stub separated from a body of the metal part by a void. Because the stub is continuous with the body of the metal part only at one surface, it is more susceptible to fracturing during the formation process. In such scenarios, it may be desirable to partially form a complex metal part by extrusion, and then shape the metal part into its desired shape via a cold drawing process.

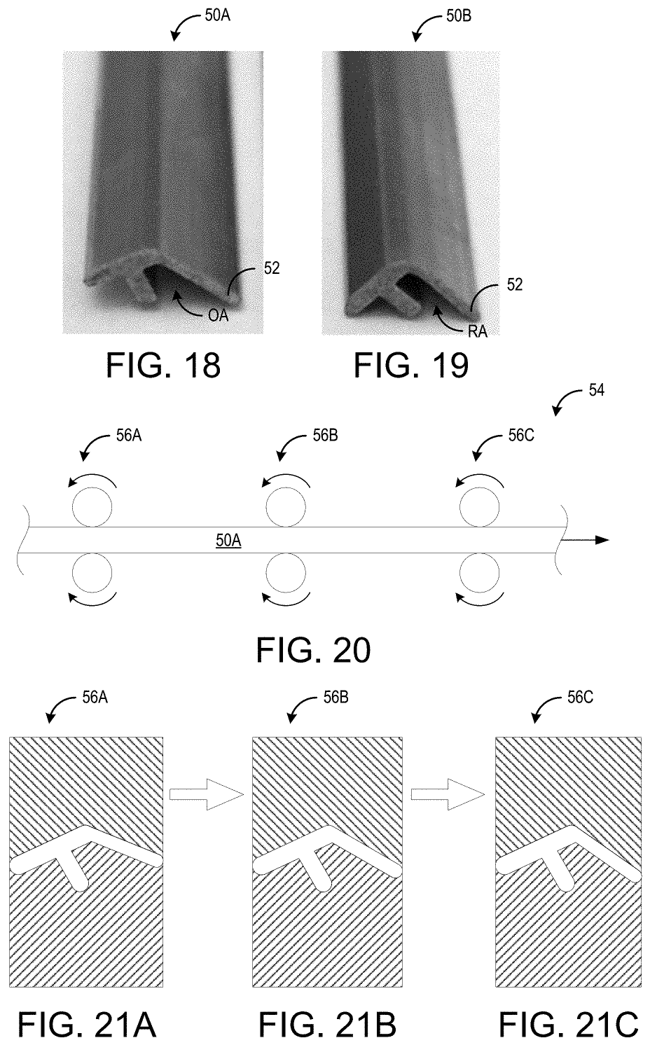

FIGS. 18 and 19 show photographic perspective views of a metal part 50A, 50B before and after shaping, respectively. As illustrated, the metal part 50A in FIG. 18 may be in a semi-finished shape that includes a stub 52 arranged at an obtuse angle OA. The metal part 50B shown in FIG. 19 may have a finished shape that forms a substantially F shape in which the stub 52 is shaped to form a substantially right angle RA. The metal part 50A may be formed by passing a metal bar or rod through a series of rollers to achieve a semi-finished shape. Alternatively, the metal part 50A may be partially formed by drawing a metal bar or rod through a die, followed by cold drawing the metal part 50A through a series of rollers to achieve the semi-finished shape.

FIG. 20 shows a schematic diagram of a cold drawing process in which the metal part 50A is passed through a series of roller sets 56A, 56B, 56C. While three roller sets are illustrated in FIG. 20, it will be appreciated that FIG. 20 is provided as a schematic illustration of a cold drawing process and is not intended to limit the number of roller sets used in the claimed cold drawing process to three. FIGS. 21A-21C show schematic views of cross-sections of the roller sets 56A, 56B, 56C used in the cold drawing process of FIG. 20. Each roller set is configured to have an increased rolling angle and compression force than a preceding roller set such that the metal part 50A is gradually deformed as is progresses from one roller set to the next. After each rolling process, the metal part 50A may be annealed to release internal stress from the force of rolling. After the final rolling process, the annealing step may be eliminated to preserve the strength and straightness of the metal part 50A. During the rolling process, the metal part 50A may configured as a long bar. When the rolling process is complete, the long bar may be cut to form several shorter parts of a desired length. Each shorter part may be forged, such as with a stamping tool, for example, to achieve a finished shape such as that indicated by the metal part 50B in FIG. 19.

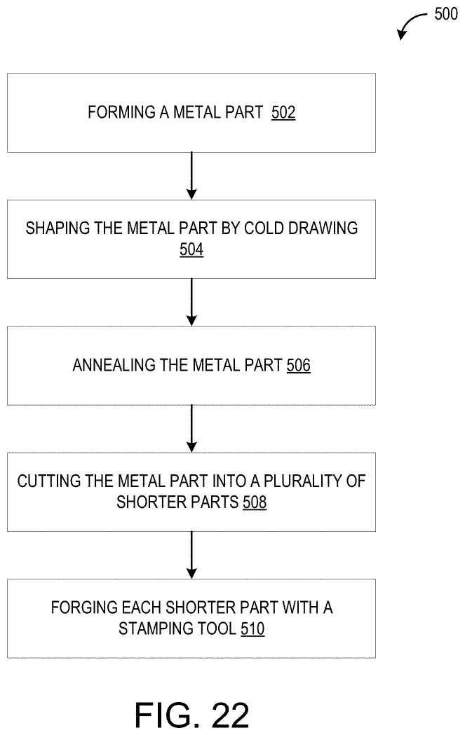

FIG. 22 shows a flowchart of a method 500 for shaping a metal part according to another implementation of the present disclosure. At step 502, the method 500 may include forming a metal part. As discussed above, the metal part 50A may be formed by passing a metal bar or rod through a series of rollers, or by drawing a metal bar or rod through a die. The resulting metal part 50A may have a semi-finished shape forming an obtuse angle. Accordingly, at step 504 the method 500 may include shaping the metal part 50A by cold-drawing the metal part 50A through a series of roller sets. As described above, each roller set 56A, 56B, 56C in the series may have an increased rolling angle and compression force than a preceding roller set. As the metal part 50A progresses from one roller set to the next, the increased rolling angle and compression force of the subsequent roller sets bend the portion of the metal part 50A. Between each rolling process, at step 506 the method 500 may include annealing the metal part 50A after cold-drawing the metal part 50A to release internal stress. At step 508, the method 500 may further include cutting the metal part 50A into a plurality of shorter parts. To achieve a finished shape, such as the metal part 50B, at step 510 the method 500 may include forging each shorter part of the plurality of shorter parts with a stamping tool such that the obtuse angle OA is formed to be a substantially right angle RA. As shown in FIG. 18, the metal part 50A may have a stub that is connected to the portion forming the obtuse angle, and, as shown in FIG. 19 the finished shape 50B may be formed substantially in an F shape.

In some embodiments, the methods and processes described herein may be tied to a computing system of one or more computing devices. In particular, such methods and processes may be implemented as a computer-application program or service, an application-programming interface (API), a library, and/or other computer-program product.

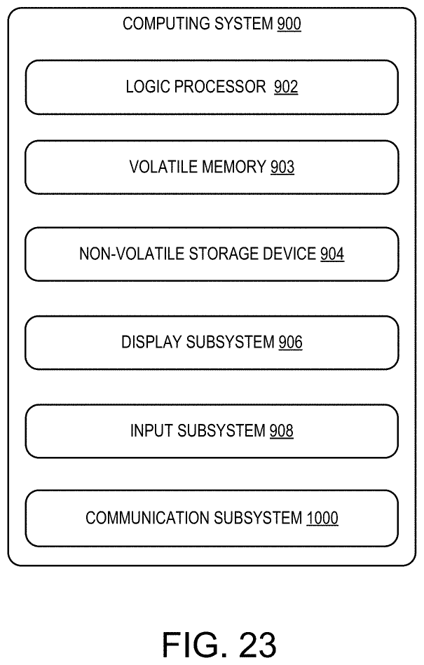

FIG. 23 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902, volatile memory 903, and a non-volatile storage device 904. Computing system 900 may optionally include a display subsystem 906, input subsystem 908, communication subsystem 1000, and/or other components not shown in FIG. 23.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in. Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a method for use in manufacturing a metal part. The method may comprise casting liquid metal in a ceramic mold, and the ceramic mold may be formed via an investment casting process. The method may comprise cooling the liquid metal in the ceramic mold to form a solid metal part. The method may comprise divesting the ceramic mold to thereby release the metal part, and the metal part may include an imperfection in a shape of the metal part. The method may comprise shaping the metal part by near-net shape forging to correct the imperfection. In this aspect, additionally or alternatively, the ceramic mold of the method may be formed by creating a master pattern for the metal part, creating a master mold from the master pattern, applying wax to the master mold to form a wax mold, releasing the wax mold from the master mold, the wax mold being in the form of the metal part, applying investment materials to the wax mold to form the ceramic mold, and dewaxing the ceramic mold by heating the ceramic mold to melt the wax.

In this aspect, additionally or alternatively, the application of investment materials to the wax mold to form the ceramic mold of the method may comprise at least one cycle of coating, wherein coating comprises dipping the wax mold into a slurry of fine refractory material, stuccoing, wherein stuccoing comprises applying coarse ceramic particles to the coated wax mold, and hardening, wherein hardening comprises allowing the coated and stuccoed wax mold to cure.

In this aspect, additionally or alternatively, the near-net shape forging of the method may comprises, creating a die set for shaping the metal piece, the die set including a forging mold and a punch, the forging mold having a void in a shape compatible with an external surface of the metal part, and the punch having a face formed in a shape compatible with an interior surface of the metal part, placing the metal part in the forging mold, applying a downward compressive force to the metal part with the punch to plastically deform the metal part to adapt to the shapes of the forging mold and the punch face, releasing the downward compressive force by lifting the punch, and ejecting the forged metal part from the forging mold. In this aspect, additionally or alternatively, the near-net shape forging of the method may be cold forging.

In this aspect, additionally or alternatively, the method may further comprise machining the metal part after forging with a computerized numerical control (CNC) machine. In this aspect, additionally or alternatively, the method may further comprise polishing the metal part after forging. In this aspect, additionally or alternatively, the method may further comprise applying a protective coating to the metal part after forging via physical vapor deposition (PVD).

In this aspect, additionally or alternatively, the die set of the method may be a first die set, and the near-net shape forging may be a multistage forging process that may comprise shaping the metal part with the first die set to correct a first imperfection, shaping the metal part with a second die set to correct a second imperfection, and shaping the metal part with a third die set to correct a third imperfection. The first imperfection, the second imperfection, and the third imperfection may be unrelated to one another.

In this aspect, additionally or alternatively, the metal part of the method may be forged to correct a torsional imperfection of the metal part. In this aspect, additionally or alternatively, the metal part of the method may be forged to correct a length of the metal part. In this aspect, additionally or alternatively, the metal part of the method may be forged to correct a width of the metal part. In this aspect, additionally or alternatively, the metal part of the method may be subjected to rough piercing to correct a dimension of a perforation. In this aspect, additionally or alternatively, the metal part of the method may be further subjected to fine piercing to correct the dimension of the perforation to a stricter dimensional tolerance than the rough piercing.

In this aspect, additionally or alternatively, the method may further comprise applying a flat press to the metal part to straighten the metal part after casting and before shaping with near-net shape forging. In this aspect, additionally or alternatively, shaping the metal piece of the method may be achieved by a single application of the punch to the metal part in the forging mold. In this aspect, additionally or alternatively, the investment casting process of the method may include forming a gating system, the gating system being removed prior to forging the metal part.

Another aspect provides a method for making a complex metal part. The method may comprise creating a master mold for the metal part, applying wax to the master mold to form a wax mold, applying investment materials to the wax mold to form a ceramic mold, dewaxing the ceramic mold by heating the ceramic mold to melt the wax, casting liquid metal in the ceramic mold and cooling the liquid metal until it forms a solid metal part, divesting the ceramic mold to thereby release the metal part formed in the shape of the ceramic mold, shaping the metal part with near-net shape forging, machining the metal part with a computerized numerical control (CNC) machine, polishing the metal part, and applying a protective coating to the metal part via physical vapor deposition (PVD).

Another aspect provides a method for shaping a metal part. The method may comprise forming a metal part, and the metal part may have a semi-finished shape forming an obtuse angle. The method may comprise shaping the metal part by cold-drawing the metal part through a series of roller sets, and each roller set in the series may have an increased rolling angle and compression force than a preceding roller set. The method may comprise annealing the metal part after cold-drawing the metal part, cutting the metal part into a plurality of shorter parts, and forging each shorter part of the plurality of shorter parts with a stamping tool to thereby bend the portion of the metal part forming the obtuse angle to a substantially right angle to achieve a finished shape. In this aspect, additionally or alternatively, the metal part of the method may include a stub connected to the portion forming the obtuse angle, and the finished shape may be formed substantially in an F shape.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for use in manufacturing a metal part, the method comprising:
casting liquid metal in a ceramic mold, the ceramic mold being formed via an investment casting process;
cooling the liquid metal in the ceramic mold to form a solid metal part;
divesting the ceramic mold to thereby release the metal part, the metal part including an imperfection in a shape of the metal part; and
shaping the metal part by near-net shape forging to correct the imperfection.

2. The method according to claim 1, wherein the ceramic mold is formed by:
creating a master pattern for the metal part;
creating a master mold from the master pattern;
applying wax to the master mold to form a wax mold;
releasing the wax mold from the master mold, the wax mold being in the form of the metal part;
applying investment materials to the wax mold to form the ceramic mold; and
dewaxing the ceramic mold by heating the ceramic mold to melt the wax.

3. The method according to claim 2, wherein applying investment materials to the wax mold to form the ceramic mold comprises at least one cycle of:
coating, wherein coating comprises clipping the wax mold into a slurry of fine refractory material;
stuccoing, wherein stuccoing comprises applying coarse ceramic particles to the coated wax mold; and
hardening, wherein hardening comprises allowing the coated and stuccoed wax mold to cure.

4. The method according to claim 1, wherein the near-net shape forging comprises:
creating a die set for shaping the metal piece, the die set including a forging mold and a punch, the forging mold having a void in a shape compatible with an external surface of the metal part, and the punch having a face formed in a shape compatible with an interior surface of the metal p art;
placing the metal part in the forging mold;
applying a downward compressive force to the metal part with the punch to plastically deform the metal part to adapt to the shapes of the forging mold and the punch face;
releasing the downward compressive force by lifting the punch; and
ejecting the forged metal part from the forging mold.

5. The method according to claim 1, wherein the near-net shape forging is cold forging.

6. The method according to claim 1, the method further comprising machining the metal part after forging with a computerized numerical control (CNC) machine.

7. The method according to claim 1, the method further comprising polishing the metal part after forging.

8. The method according to claim 1, the method further comprising applying a protective coating to the metal part after forging via physical vapor deposition (PVD).

9. The method according to claim 4, wherein the die set is a first die set, and the near-net shape forging is a multistage forging process comprising:
shaping the metal part with the first die set to correct a first imperfection;
shaping the metal part with a second die set to correct a second imperfection; and
shaping the metal part with a third die set to correct a third imperfection;
wherein the first imperfection, the second imperfection, and the third imperfection are unrelated to one another.

10. The method according to claim 1, wherein the metal part is forged to correct a torsional imperfection of the metal part.

11. The method according to claim 1, wherein the metal part is forged to correct a length of the metal part.

12. The method according to claim 1, wherein the metal part is forged to correct a width of the metal part.

13. The method according to claim 1, wherein the metal part is subjected to rough piercing to correct a dimension of a perforation.

14. The method according to claim 13, wherein the metal part is further subjected to fine piercing to correct the dimension of the perforation to a stricter dimensional tolerance than the rough piercing.

15. The method according to claim 1, the method further comprising applying a flat press to the metal part to straighten the metal part after casting and before shaping with near-net shape forging.

16. The method according to claim 4, wherein shaping the metal piece is achieved by a single application of the punch to the metal part in the forging mold.

17. The method according to claim 1, wherein the investment casting process includes forming a gating system, the gating system being removed prior to forging the metal part.

18. A method for making a complex metal part, the method comprising:
creating a master mold for the metal part;
applying wax to the master mold to form a wax mold;
applying investment materials to the wax mold to form a ceramic mold;
dewaxing the ceramic mold by heating the ceramic mold to melt the wax;
casting liquid metal in the ceramic mold and cooling the liquid metal until it forms a solid metal part;
divesting the ceramic mold to thereby release the metal part formed in the shape of the ceramic mold;
shaping the metal part with near-net shape forging;
machining the metal part with a computerized numerical control (CNC) machine;
polishing the metal part; and
applying a protective coating to the metal part via physical vapor deposition (PVD).

19. A method for shaping a metal part, the method comprising:
forming a metal part, the metal part having a semi-finished shape forming an obtuse angle;
shaping the metal part by cold-drawing the metal part through a series of roller sets, each roller set in the series having an increased rolling angle and compression force than a preceding roller set;
annealing the metal part after cold-drawing the metal part;
cutting the metal part into a plurality of shorter parts; and
forging each shorter part of the plurality of shorter parts with a stamping tool to thereby bend the portion of the metal part forming the obtuse angle to a substantially right angle to achieve a finished shape.

20. The method of claim 19, wherein the metal part further includes a stub connected to the portion forming the obtuse angle, the finished shape is formed substantially in an F shape.
